(19) United States
(12) Patent Application Publication
(10) Pub. No.: US 2014/0324192 A1
(43) Pub. Date: Oct. 30, 2014

(54) USER ACTIVITY-BASED MODE CREATION IN AN AUTOMATION SYSTEM

(71) Applicant: VERIZON PATENT AND LICENSING, INC., Basking Ridge, NJ (US)

(72) Inventors: Arjun Baskaran, Chennai (IN); Raja Sundaram Ganesan, Chennai (IN)

(73) Assignee: Verizon Patent and Licensing, Inc., Basking Ridge, NJ (US)

(21) Appl. No.: 13/873,552

(22) Filed: Apr. 30, 2013

(51) Int. Cl. G05B 15/02

(52) U.S. Cl. CPC G05B 15/02
USPC 700/19; 700/275; 700/90

(57) ABSTRACT

Method, device, and storage medium for receiving a request to change a state of one or multiple elements of an automation system; changing the state of the one or multiple elements based on the request; storing usage activity data of the one or multiple elements; analyzing the usage activity data using a pattern recognition metric; determining whether a usage pattern exits based on the pattern recognition metric; creating a user activity mode in response to determining that the usage pattern exists; and operating the automation system in accordance with the user activity mode.

### BACKGROUND

A home or a building automation system provides a user with the ability to control various devices located in the home, place of business, etc. The automation system includes a controller to control various devices, such as, cameras, door and window sensors, motion detectors, heating, ventilation, and air conditioning (HVAC), lighting and appliance controllers, etc. The user is able to control the automation system on-location, remotely, or both.

### BRIEF DESCRIPTION OF THE DRAWINGS

FIG. 1A is a diagram illustrating an exemplary environment in which an exemplary embodiment of an automation system including a user activity mode may be implemented.

FIG. 1B is a diagram illustrating an exemplary implementation of an exemplary embodiment of the automation system illustrated in FIG. 1A

FIG. 2A is a diagram illustrating an exemplary embodiment of a control device;

FIG. 2B is a diagram of exemplary usage activity data;

FIGS. 3A-3D are diagrams illustrating an exemplary process to automatically identify a usage pattern of an automation system and automatically create a user activity mode;

FIG. 4 is a diagram illustrating exemplary components of a device that may correspond to one or more of the devices previously depicted;

FIG. 5 is a flow diagram illustrating an exemplary process pertaining to an exemplary embodiment of an automation system;

FIG. 6 is a diagram illustrating an exemplary environment in which an exemplary embodiment of an automation system including a user activity mode based on an aggregator device may be implemented;

FIG. 7A is a diagram of an exemplary embodiment of an aggregator device;

FIG. 7B is a diagram of exemplary usage activity data fields;

FIGS. 8A and 8B are diagrams illustrating another exemplary process to automatically identify a usage pattern of an automation system and automatically create a user activity mode; and

FIG. 9 is a flow diagram illustrating an exemplary process pertaining to an exemplary embodiment of an automation system with an aggregator device.

### DETAILED DESCRIPTION OF PREFERRED EMBODIMENTS

The following detailed description refers to the accompanying drawings. The same reference numbers in different drawings may identify the same or similar elements.

According to an exemplary embodiment, an automation system (e.g., a home automation system, a building automation system, a monitoring and control system, etc.), includes behavioral analytics to identify patterns of usage. The automation system stores usage activity pertaining to each automatable element of the automation system. The behavioral analytics identifies a pattern of usage based on the stored usage activity. According to an exemplary embodiment, the behavioral analytics identifies a usage pattern based on a pattern recognition metric (e.g., a frequency-over-time period).

According to an exemplary embodiment, the automation system creates a user activity mode in response to determining that a pattern of usage exists. According to an exemplary embodiment, the automation system automatically invokes the user activity mode to allow the automation system to operate according to the user's pattern of usage.

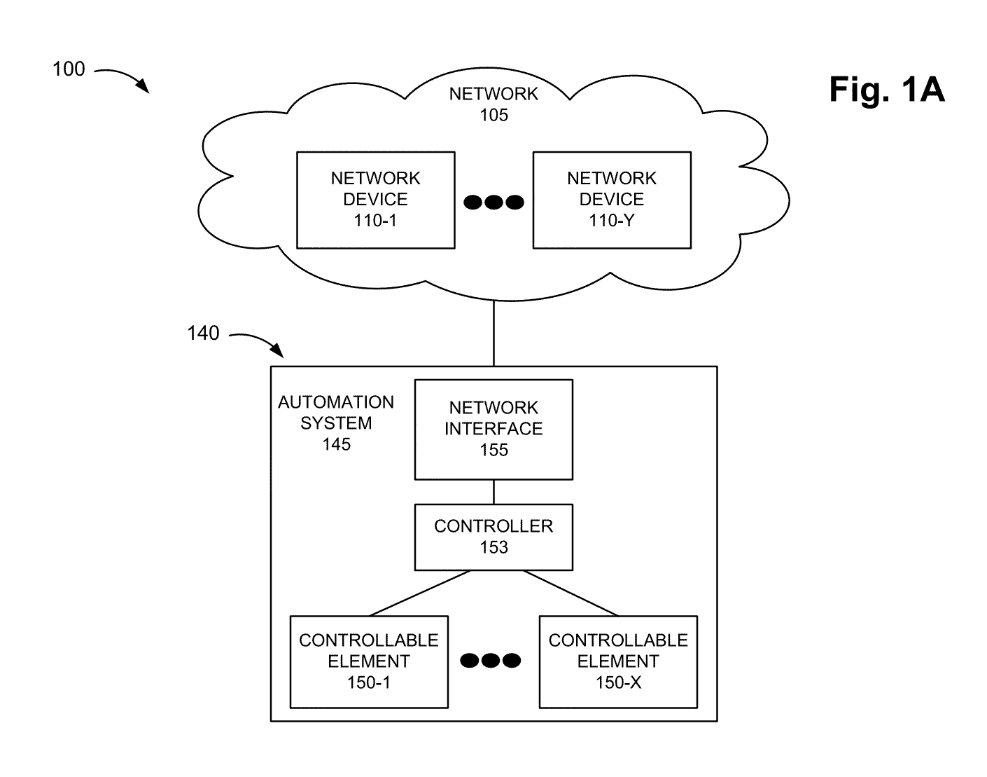

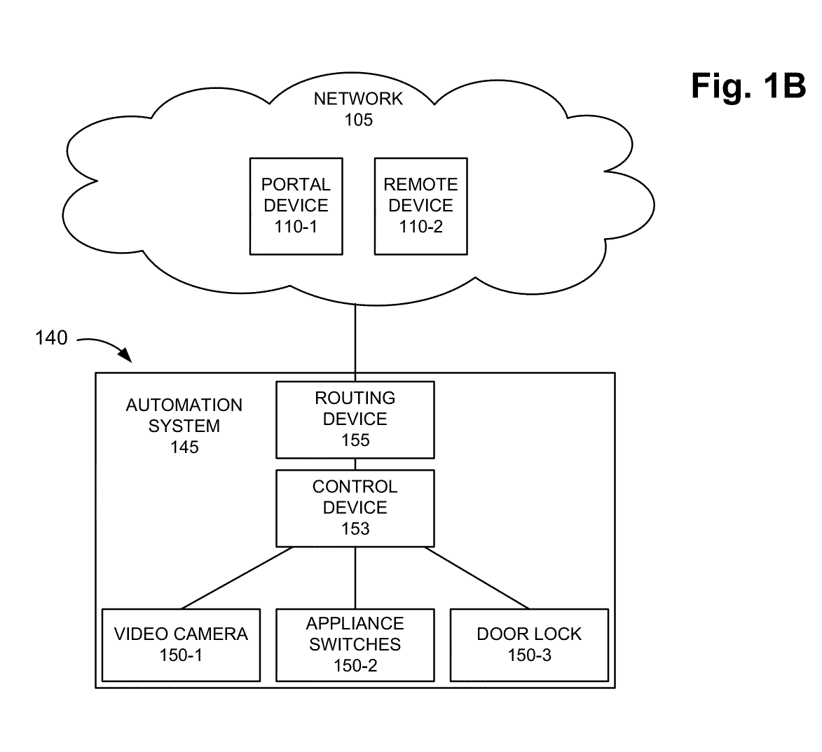

FIG. 1A is a diagram illustrating an exemplary environment in which an exemplary embodiment of an automation system including a user activity mode may be implemented. As illustrated, an environment 100 includes a network 105 and a customer's premises 140. Network 105 includes network devices 110-1 through 110-Y, in which Y>1 (also referred to collectively as network devices 110 and individually as network device 110). Customer's premises 140 include an automation system 145. Automation system 145 includes controllable elements 150-1 through 150-X, in which X>1 (also referred to collectively as controllable elements 150 and individually as controllable element 150), a controller 153, and a network interface 155.

The number of devices and networks, and the configuration in environment 100 are exemplary. According to other embodiments, environment 100 may include additional devices, fewer devices, different devices, and/or differently arranged devices, than those illustrated in FIG. 1A. Additionally, or alternatively, environment 100 may include an additional network and/or a differently arranged network, than those illustrated in FIG. 1A.

According to other embodiments, a single device in FIG. 1A may be implemented as multiple devices. Alternatively, for example, multiple devices in FIG. 1A may be implemented as a single device. For example, multiple devices of network devices 110 may be implemented as a single device. A device may be implemented according to one or multiple network architectures (e.g., a client device, a server device, a peer device, a proxy device, or a combination thereof).

Also, according to other embodiments, one or more functions and/or processes described as being performed by a particular device may be performed by a different device, or some combination of devices, which may or may not include the particular device.

Environment 100 may be implemented to include wired and/or wireless connections among the devices and networks illustrated. A connection may be direct or indirect and may involve intermediary device(s) and/or network(s) not illustrated in FIG. 1A. Additionally, the number and the arrangement of connections between the devices and the networks are exemplary.

Network 105 includes a network that provides monitoring and control services. For example, users may subscribe to a monitoring and control service provided by network 105. Network 105 may be implemented as, for example, a cloud service, the Internet, a private Internet Protocol (IP) network, a wide area network, a metropolitan area network, a data network, a wireless network, a computer network, or some combination thereof.

Network devices 110 include network devices that provide, for example, user interfaces, authentication and authorization, and communication to automation system 145 located at customer's premises 140. Network devices 110 may be implemented as, for example, a cloud device, an application server device, a web server device, a storage device, or some combination thereof.

Customer's premises 140 are a location at which automation system 145 is located. For example, customer's premise 140 may be the user's residence, place of business, etc. Controllable elements 150 are elements of automation system 145 that are capable of being controlled and monitored. Additionally, controllable elements 150 are elements of automation system 145 that are capable of being automated based on a user activity mode, as described herein. By way of example, controllable elements 150 may include a video camera, an appliance switch, a door lock element, a door sensor, a window sensor, a motion detector, an HVAC element, or other well-known element (e.g., a light dimmer, an alarm system, etc.) that may be incorporated into a monitoring and control system.

Controller 153 includes a computational device that operates as a central intelligence node of automation system 145. Controller 153 provides various user interfaces to allow a user to control controllable elements 150. Controller 153 communicates with controllable elements 150 to cause controllable elements 150 to perform certain functions (e.g., turn on, turn off, lock, unlock, record, play, etc.). Controller 153 includes a behavioral analytics engine, as described herein. For example, the behavioral analytics engine identifies usage patterns of automation system 145 based on usage activity data and one or multiple pattern recognition metrics. For example, a pattern recognition metric may include a frequency or a duration of a state of controllable element 150 relative to a time period. The behavioral analytics engine creates a user activity mode when a usage pattern is identified. Controller 153 and controllable elements 150 operate according to the user activity mode.

Network interface 155 includes a device that interfaces with network 105. For example, network interface 155 may be implemented as a router (e.g., an in-home router device, a broadband router, a wireless router, etc.). Customer's premise 140 may include other devices not specifically illustrated in FIG. 1A, such as an optical network termination device, a media server device, etc. Additionally, or alternatively, automation system 145 may include other devices or elements, such as a remote control, a key fob, software on a set top box to allow the user to monitor and control controllable elements 150, etc.

FIG. 1B is a diagram illustrating an exemplary implementation of an exemplary embodiment of the automation system illustrated in FIG. 1A. As illustrated, network 105 includes a portal device 110-1 and a remote device 110-2. Customer's premises 140 include a video camera 150-1, appliance switches 150-2, a door lock 150-3, a control device 153, and a routing device 155.

Portal device 110-1 includes a network device that provides access to monitoring and control services provided by network 105. For example, portal device 110-1 provides user interfaces to allow a user to sign on to monitoring and control services. Portal device 110-1 may allow the user to view account and billing information, request new equipment, etc.

Remote device 110-2 includes a network device that provides user interfaces for monitoring and controlling automation system 145. For example, the user may monitor and control video camera 150-1, appliance switches 150-2, and door lock 150-3 from a remote location via remote device 110-2. Remote device 110-2 acts as an intermediary device for communications between a user device (e.g., a computer, a smartphone, etc.) (not illustrated) and control device 153. Remote device 110-2 packages communications (e.g., stream signaling and video content, commands, etc.) between the user device and automation system 145.

Referring to automation system 145, video camera 150-1 includes a video camera device that captures video. Video camera 150-1 may include a mechanism to allow video camera 150-1 to move (e.g., pan, pivot, etc.). Appliance switches 150-2 include switches (e.g., on/off switch, timer switch, light switch, appliance switch, etc.) to control the operation of a light or a device. Door lock 150-3 includes a door lock and keypad entry/exit mechanism to allow individuals to enter or exit a door.

Control device 153 includes a device that communicates and controls the operation of video camera 150-1, appliance switches 150-2, and door lock 150-3 at customer's premises 140. For example, control device 153 includes a central logic engine that provides user interfaces, allows for programming various operational settings, and allows for one or multiple modes of operation. According to an exemplary embodiment, control device 153 operates in a user activity mode. According to an exemplary implementation, control device 153 communicates with video camera 150-1, appliance switches 150-2, and door lock 150-3 using Z-Wave. According to other implementations, control device 153 communicates with video camera 150-1, appliance switches 150-2, and door lock 150-3 using other well-known wireless technologies and communication protocols. Control device 153 is communicatively coupled to routing device 155 (e.g., via WiFi or other suitable communication standard).

Routing device 155 includes any suitable routing device, such as a wireless router, a broadband router, etc. Routing device 155 is communicatively coupled to network 105 and control device 153.

According to an exemplary embodiment, automation system 145 operates according to a mode. For example, according to an exemplary embodiment, automation system 145 operates according to a scheduled mode. As an example, a user may configure automation system 145 to operate in a night time mode. The night time mode may be manually invoked by the user or occur automatically at a certain time. Alternatively, according to an exemplary embodiment, automation system 145 operates according to a triggering mode. For example, when motion is detected (e.g., via a motion sensor), such as when the user opens or closes a door, automation system 145 operates in the triggering mode. Alternatively, automation system 145 operates according to on-demand mode. For example, the user may request to turn on a light via a remote control, via a television, or via a mobile device that is communicatively coupled to automation system 145.

In contrast to the above-mentioned modes, according to an exemplary embodiment, automation system 145 operates according to a user activity mode. As previously described, the user activity mode is a mode of operation according to patterned usage of automation system 145. Automation system 145 automatically identifies a pattern of usage based on usage activity data. Automation system 145 automatically creates the user activity mode in response to identifying the pattern of usage.

According to an exemplary embodiment, automation system 145 includes user preferences pertaining to the identification of the pattern of usage. For example, the user may opt in or opt out of this service. Additionally, the user may include all controllable elements 150 to be analyzed for a pattern of usage or omit/include particular controllable elements 150. Additionally, or alternatively, the user may omit/include particular time periods (e.g., daytime, between certain hours, certain days, etc.).

According to an exemplary embodiment, the user may set a user preference pertaining to whether the user would like to be notified when a pattern of usage is identified. If the user chooses to be notified, the user may review the pattern of usage and approve or deny (in whole or in part) the pattern of usage. For example, control device 150 may generate an alert (e.g., an auditory alert) or a message, which is displayed via a user interface of control device 153, to indicate to the user that a usage pattern has been identified. According to an exemplary implementation, control device 150 may provide a user interface for the user to review and accept the usage pattern.

Alternatively, control device 153 may cause a message (e.g., a text message, an automated telephone message, etc.) to be transmitted to a user device (e.g., a smartphone, etc.) associated with the user. Alternatively, the user may review and accept the usage pattern over the telephone, via a web interface, via a text message, etc. If the user chooses not to be notified, automation system 145 automatically creates the user activity mode.

According to an exemplary embodiment, automation system 145 creates a user activity mode when a pattern of usage is identified. For example, automation system 145 creates a configuration setting that includes configuration setting data corresponding to the usage pattern.

The time at which, for example, the user may turn on or turn off a light may vary day-to-day during the pattern of usage time period. In view of this fact, automation system 145 may create a time setting according to various implementations. For example, automation system 145 may average the times or select the earliest time. Alternatively, automation system 145 may select a time closest to a predefined increment of time (e.g., on the hour, on the half-hour, fifteen minute increment, etc.). For example, assume the user turns on the light at 5:54 p.m., 5:56 p.m., 5:57 p.m., 5:58 p.m., 6:01 p.m., 6:00 p.m., and 6:05 p.m. Automation system 145 may select the time setting to turn on the light at 6:00 p.m. Alternatively, automation system 145 may select the time setting to turn on the light at 5:55 p.m. In that case, automation system 145 selects a target time (e.g., 6:00) and an early time increment (e.g., five minutes) and subtracts the early time increment from the target time to arrive at the time setting (e.g., 5:55 p.m.). According to an exemplary embodiment, automation system 145 includes user preferences pertaining to the creation of the user activity mode. For example, the user may select whether automation system 145 averages the times, selects the earliest time, etc., as described above. Automation system 145 allows the user to delete or modify the user activity mode after it is created. A further description of the user activity mode is presented below.

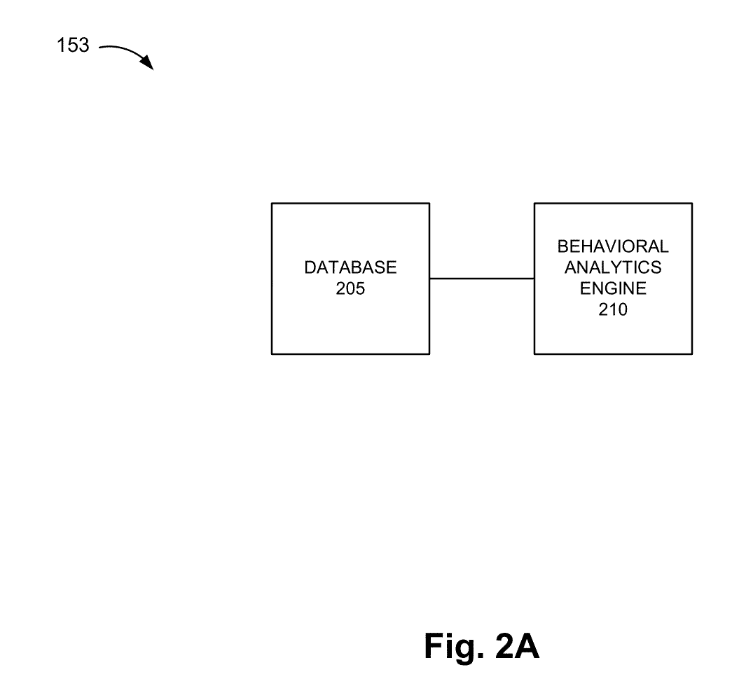

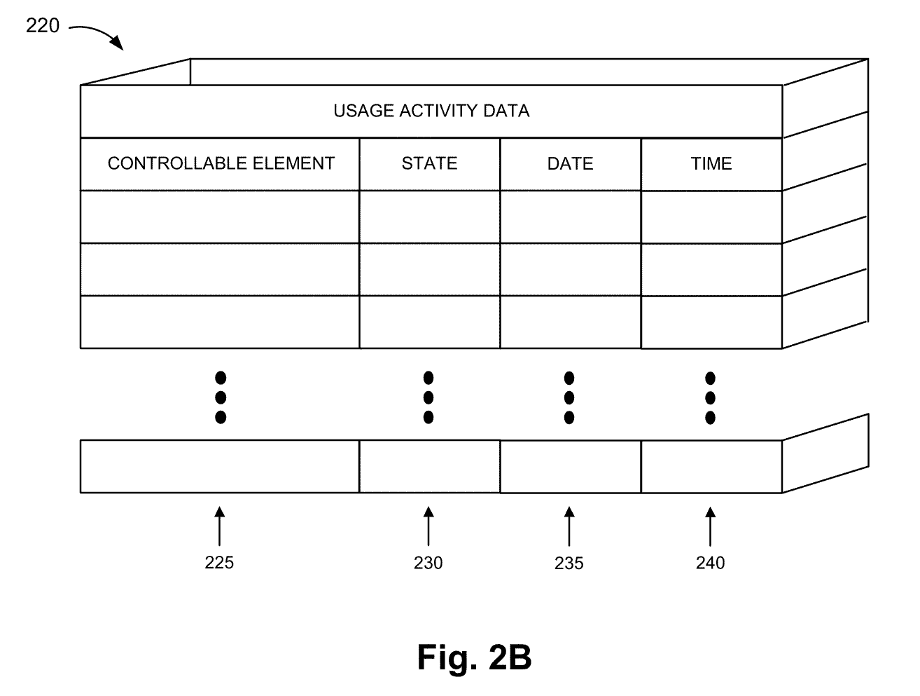

FIG. 2A is a diagram illustrating an exemplary embodiment of control device 153. As illustrated, control device 153 includes a database 205 and a behavioral analytics engine 210.

Database 205 stores usage activity data. The usage activity data relates to the operation of automation system 145. FIG. 2B is a diagram of exemplary usage activity data fields to store usage activity data. As illustrated, an exemplary table 220 includes a controllable element field 225, a state field 230, a date field 235, and a time field 240. According to other implementations, table 220 may include additional fields, fewer fields, and/or different fields than those illustrated and described herein. For example, table 220 may include a user identifier field that identifies the user or automation system 145 (e.g., a unique string) associated with the user. Additionally, or alternatively, table 220 may include a location identifier field that identifies the geographic location of automation system 145 (e.g., city, state, country, zip code, etc.).

Controllable element field 225 stores data that indicates or identifies a controllable element 150 of automation system 145. For example, controllable element data may identify an appliance switch, a video camera, a door lock, a motion sensor, a door sensor, etc.

State field 230 stores data that indicates a state of controllable element 150. Depending on controllable element 150, state data may be different relative to other controllable elements 150. For example, if controllable element 150 is an appliance switch, state data may indicate an on state or an off state. If controllable element 150 is a video camera, state data may indicate a play state, a record state, etc. Additionally, state data may indicate a position or an orientation (e.g., X, Y, and/or Z axes) of video camera or other operation (e.g., panning left to right, zooming, etc.) relating to the video camera. Similarly, if controllable element 150 is a door lock element, state data may indicate a locked state, an unlocked state, etc. Other states may be envisioned in correspondence to the type of controllable element 150.

Date field 235 stores data that indicates a date. For example, date data may store a month, a day, and a year pertaining to the state of controllable element 150. Date data may also store the day of the week (e.g., Monday, Tuesday, etc.). Time field 240 stores data that indicates a time. For example, time data may store an hour, a minute, and second pertaining to the state of controllable element 150. In some instances, time field 240 may store data that indicates a period of time (e.g., noon-5:00:12 p.m.). In other instances, time field 240 may store data that corresponds to a timestamp or an instance in time.

Behavioral analytics engine 210 identifies a usage pattern based on the usage activity data stored in database 205. According to an exemplary embodiment, behavioral analytics engine 210 identifies a usage pattern based on a pattern recognition metric. For example, behavioral analytics engine 210 analyzes each controllable element identifier stored in controllable element field 225 and state data stored in state field 230 to identify a pattern of usage in relation to date and time data stored in fields 235 and 240.

According to an exemplary implementation, behavioral analytics engine 210 applies a threshold quantitative metric as a measurement of a usage pattern. By way of example, a three times/per week threshold or some other ratio/values may be used as a minimum measurement of a usage pattern. According to an exemplary embodiment, the frequency (e.g., three times) and the time period (e.g., one week) may be user configurable. Alternatively, automation system 145 may use a default value. Behavioral analytics engine 210 may identify a usage pattern based on user preference settings, as previously described, in combination with the pattern recognition metric.

Behavioral analytics engine 210 creates a user activity mode when a usage pattern is identified. For example, behavioral analytics engine 210 creates configuration setting data that control device 153 uses to control the operation of controllable elements 150. The configuration setting data may include data similar to the usage activity data (e.g., a controllable element identifier, state data, date data, and time data).

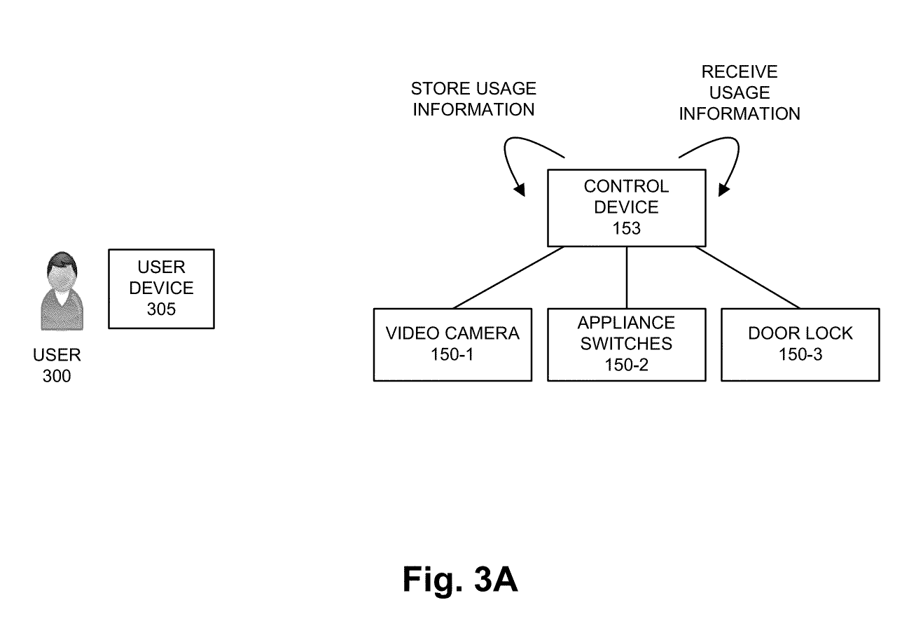

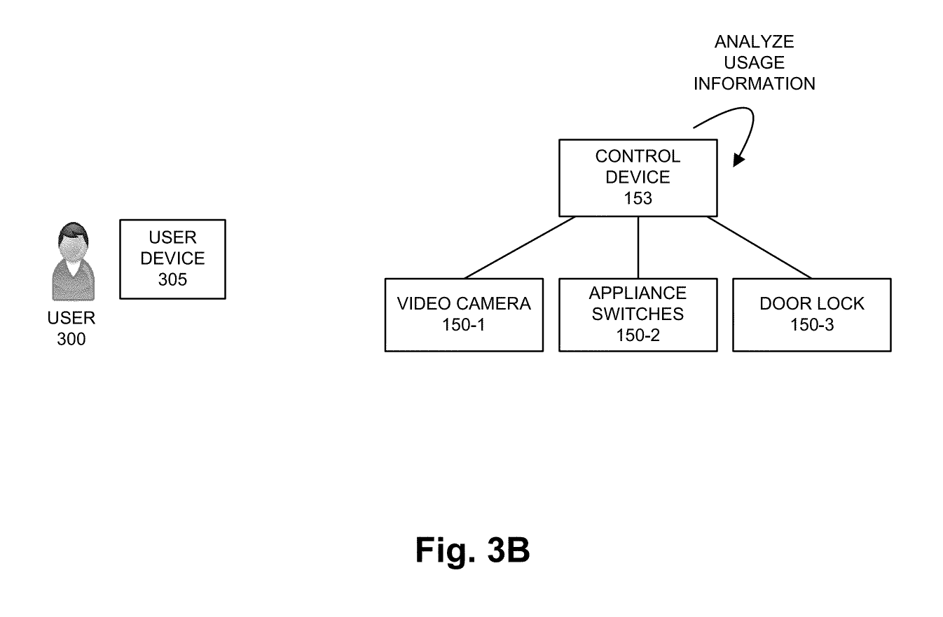

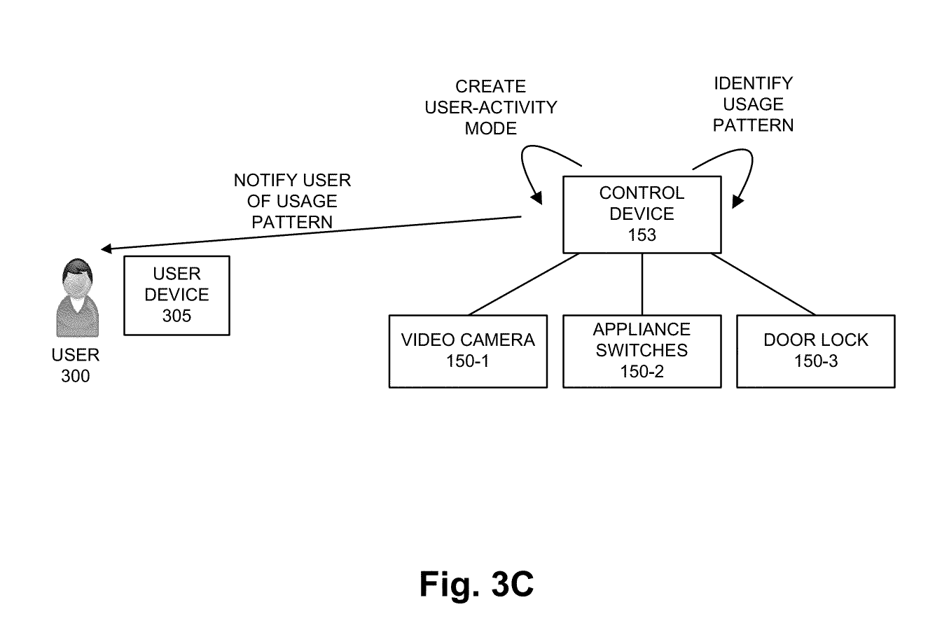

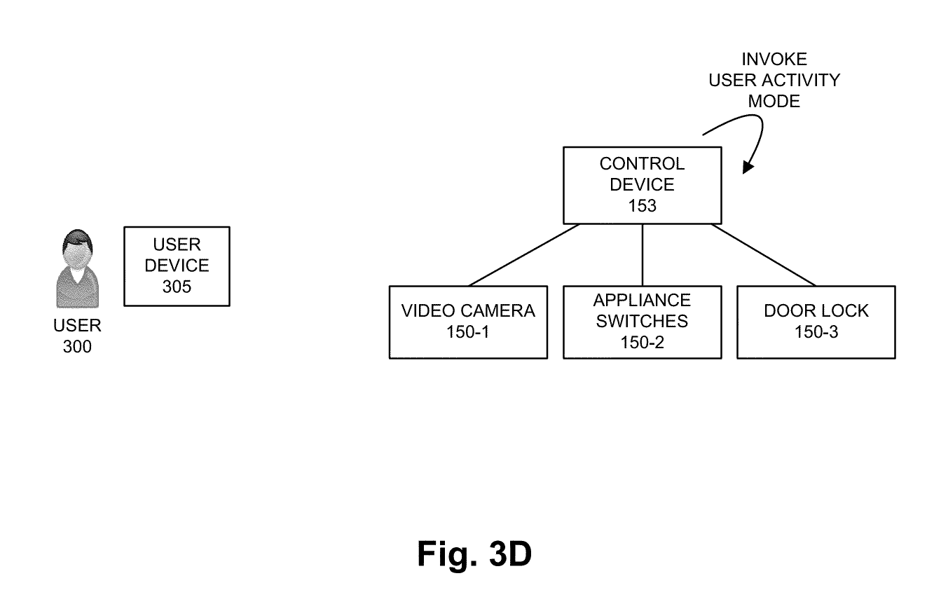

FIGS. 3A-3D are diagrams illustrating an exemplary process to automatically identify a usage pattern of automation system 145 and automatically create a user activity mode. Referring to FIG. 3A, assume a user 300 operates a user device 305 (e.g., a remote control) to make several on-demand requests to control device 153 to set appliance switches 150-2. Upon receiving the on-demand requests, control device 153 communicates with appliance switches 150-2. Appliance switches 150-2 operate according to the on-demand requests. For example, user 300 turns on and turns off various lights and turns on a television to watch his or her favorite program. Control device 153 stores the usage activity data in database 205. For purposes of this example, assume that the user's behavior repeats itself over the course of three weeks on a Monday through Friday basis.

Referring to FIG. 3B, behavioral analytics engine 210 of control device 153 analyzes the data stored in database 205. For purposes of this example, assume that a threshold frequency-over-time-period metric is met and behavioral analytics engine 210 identifies a usage pattern based on an analysis of the usage activity data stored in database 205, as illustrated in FIG. 3C. For purposes of this example, control device 153 notifies user 300 of the usage pattern and user 300 accepts via a user interface provided by control device 153. Behavioral analytics engine 210 creates a configuration setting according to the identified usage pattern. Behavioral analytics engine 210 stores configuration setting data.

Referring to FIG. 3D, control device 153 operates in the user activity mode based on the configuration setting data. For example, control device 153 causes various lights to turn on and turn off and turns on the television to allow user 300 to watch his or her favorite program at the appropriate time during the week.

While FIGS. 3A-3D are diagrams illustrating an exemplary process performed by an exemplary embodiment of automation system 145, according to other use case scenarios, the step(s) or act(s) described may be different.

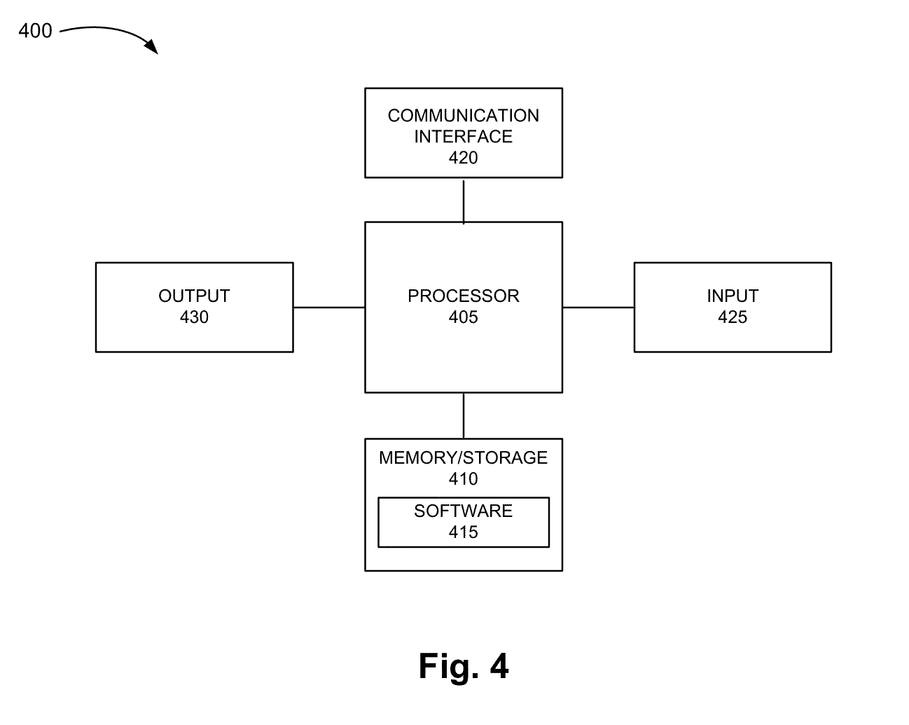

FIG. 4 is a diagram illustrating exemplary components of a device 400 that may correspond to one or more of the devices depicted in the previous figures. For example, device 400 may correspond to components of control device 153, portal device 110-1, remote device 110-2, and user device 305. As illustrated, according to an exemplary embodiment, device 400 includes a processor 405, memory/storage 410, software 415, a communication interface 420, an input 425, and an output 430. According to other embodiments, device 400 may include fewer components, additional components, different components, and/or a different arrangement of components than those illustrated in FIG. 4 and described herein.

Processor 405 includes one or multiple processors, microprocessors, data processors, co-processors, multi-core processors, application specific integrated circuits (ASICs), controllers, programmable logic devices, chipsets, field programmable gate arrays (FPGAs), system on chips (SoCs), programmable logic devices (PLSs), microcontrollers, application specific instruction-set processors (ASIPs), central processing units (CPUs), or some other component that interprets and/or executes instructions and/or data. Processor 405 may be implemented as hardware (e.g., a microprocessor, etc.) or a combination of hardware and software (e.g., a SoC, an ASIC, etc.). Processor 405 may include one or multiple memories (e.g., memory/storage 410), etc.

Processor 405 may control the overall operation, or a portion of operation(s) performed by device 400. Processor 405 may perform one or multiple operations based on an operating system and/or various applications or programs (e.g., software 415). Processor 405 may access instructions from memory/storage 410, from other components of device 400, and/or from a source external to device 400 (e.g., another device, a network, etc.).

Memory/storage 410 includes one or multiple memories and/or one or multiple other types of storage mediums. For example, memory/storage 410 may include one or multiple types of memories, such as, random access memory (RAM), dynamic random access memory (DRAM), cache, read only memory (ROM), a programmable read only memory (PROM), a static random access memory (SRAM), a single in-line memory module (SIMM), a dual in-line memory module (DIMM), a flash memory, and/or some other type of memory. Memory/storage 410 may include a hard disk (e.g., a magnetic disk, an optical disk, a magneto-optic disk, a solid state disk, etc.) and a corresponding drive. Memory/storage 410 may include a hard disk (e.g., a magnetic disk, an optical disk, a magneto-optic disk, a solid state disk, etc.), a Micro-Electromechanical System (MEMS)-based storage medium, and/or a nanotechnology-based storage medium. Memory/storage 410 may include drives for reading from and writing to the storage medium.

Memory/storage 410 may be external to and/or removable from device 400, such as, for example, a Universal Serial Bus (USB) memory stick, a dongle, a hard disk, mass storage, off-line storage, or some other type of storage medium (e.g., a compact disk (CD), a digital versatile disk (DVD), a Blu-Ray® disk (BD), etc.). Memory/storage 410 may store data, software, and/or instructions related to the operation of device 400

Software 415 includes an application or a program that provides a function and/or a process. Software 415 may include firmware. For example, with reference to control device 153, software 415 may include an application that, when executed by processor 405, provides the functions of behavioral analytics engine 210, as described herein.

Communication interface 420 permits device 400 to communicate with other devices, networks, systems and/or the like. Communication interface 420 includes one or multiple wireless interface(s) and/or wired interface(s). For example, communication interface 420 may include one or multiple transmitter(s) and receiver(s), or transceiver(s).

Input 425 provides an input into device 400. For example, input 425 may include a keyboard, a keypad, a touchscreen, a touch pad, a touchless screen, a mouse, an input port, a button, a switch, a microphone, a knob, and/or some other type of input.

Output 430 provides an output from device 400. For example, output 430 may include a display, a speaker, a light (e.g., light emitting diode(s), etc.), an output port, a vibratory mechanism, and/or some other type of output.

Device 400 may perform a function or a process in response to processor 405 executing software instructions stored by memory/storage 410. For example, the software instructions may be stored in memory/storage 410 based on a loading from another memory/storage 410 of device 400 or stored into memory/storage 410 based on a loading from another device via communication interface 420. The software instructions stored in memory/storage 410 may cause processor 405 to perform processes described herein. Alternatively, according to another implementation, device 400 may perform a process or a function based on the execution of hardware (e.g., processor 405, etc.).

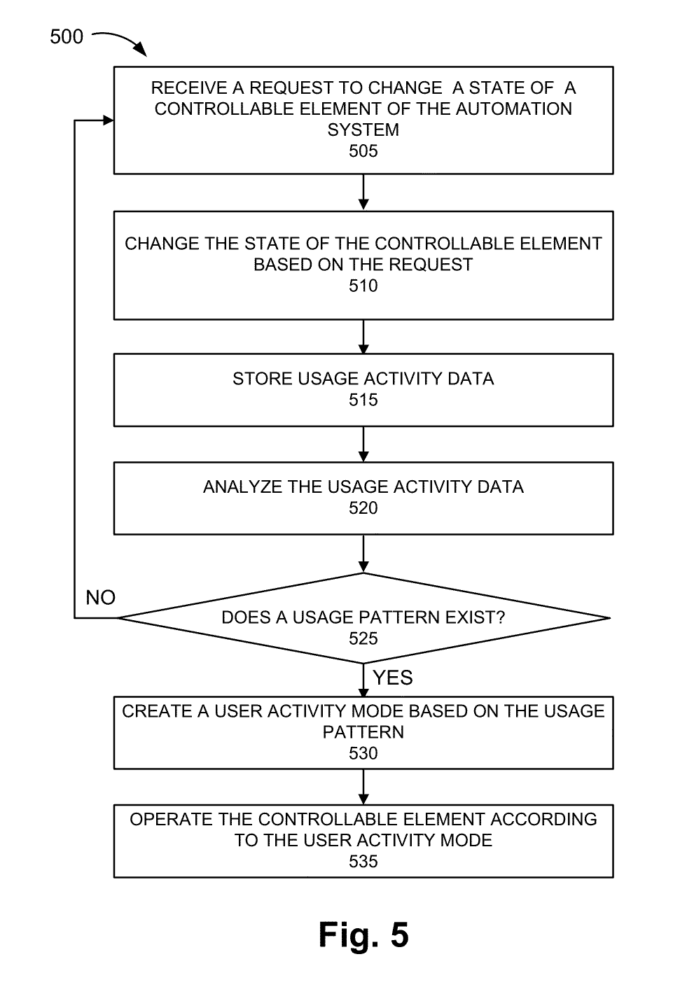

FIG. 5 is a flow diagram illustrating an exemplary process pertaining to an exemplary embodiment of automation system 145. A step described in process 500 is performed by one of the devices illustrated in FIG. 1A. For example, processor 405 of control device 153 may execute software 415 to perform the step described.

Process 500 begins with a request to change a state of a controllable element of the automation system is received (block 505). For example, a user-based request (e.g., an on-demand request) or a device-based request (e.g., a triggered-based request, such as a motion sensor, etc.) is received by control device 153 to change the state of controllable element 150 of automation system 145. As previously described, depending on controllable element 150, the change of state may include turning on, turning off, recording video, panning a video camera, locking a door, etc.

In block 510, the state of the controllable element is changed based on the request. For example, in response to receiving the request, control device 153 transmits a message to controllable element 150 that causes controllable element 150 to change its state.

In block 515, the usage activity data is stored. For example, control device 153 stores the usage activity data of controllable element 150 in database 205.

In block 520, the usage activity data is analyzed. For example, behavioral analytics engine 210 analyzes the usage activity data of controllable element 150. For example, as previously described, behavioral analytics engine 210 analyzes the usage activity data based on a pattern recognition metric to determine whether a usage pattern exists. According to an exemplary implementation, the metric includes a frequency-over-time period metric. Behavioral analytics engine 210 may also analyze the usage activity data based on user preferences, as previously described.

In block 525, it is determined whether a usage pattern exists. For example, behavioral analytics engine 210 determines whether a usage pattern exists based on the analysis of the usage activity data. If it is determined that a usage pattern does not exist (block 525—NO), then process 500 continues to block 505. For example, behavioral analytics engine 210 determines that a usage pattern does not exist based on the pattern recognition metric, the user preferences, or a combination of both.

If it is determined that a usage pattern does exist (block 525—YES), then a user activity mode is created based on the usage pattern (block 530). For example, behavioral analytics engine 210 creates a user activity mode based on the recognized usage pattern. As previously described, the behavioral analytics engine 210 creates a configuration setting that includes data corresponding to the usage pattern. For example, configuration setting data may include usage activity data (e.g., a controllable element identifier that identifies controllable element 150, state data, date data, and time data). Behavioral analytics engine 210 stores the configuration setting.

In block 535, the controllable element operates according to the user activity mode. For example, control device 153 controls controllable element 150 based on the stored configuration setting.

Although FIG. 5 illustrates an exemplary process 500 to automatically create a user activity mode of operation of an automated system, according to other implementations, process 500 may include additional operations, fewer operations, and/or different operations than those illustrated in FIG. 5 and described herein. For example, according to an exemplary embodiment, behavioral analytics engine 210 may automatically update the user activity mode based on time and/or location of the automation system 145. By way of example, behavioral analytics engine 210 may make incremental changes to the configuration setting data to account for seasonal changes. For example, a light in the living room may automatically turn on at a certain time when automation system 145 operates in user activity mode. The configuration setting data may be based on a time period from mid-April to mid-May. As time passes from mid-May through June 21^{st} (e.g., the summer solstice), behavioral analytics engine 210 modifies the turn-on time of the light in the living room to account for the gradually increasing daylight available in the living room. According to an exemplary implementation, automation system 145 considers the location of automation system 145 to calculate the incremental change in time (e.g., 2-3 seconds per day, etc.).

According to an exemplary embodiment, automation system 145 provides other forms of updates. For example, automation system 145 updates the user activity mode based on user behavior when automation system 145 operates in the user activity mode. Referring to the previous example, assume the user turns off a light that is turned on by the automation system 145 when operating in the user activity mode. Automation system 145 may automatically update the configuration setting data based on this user behavior so that next time the user activity mode is invoked, the light does not turn on. In this way, the user's behavior serves as a positive or a negative reinforcement pertaining to the user activity mode setting. According to an exemplary embodiment, automation system 145 may notify the user that a change to the user activity mode will take place. The user may accept or deny the update.

According to another exemplary embodiment, an automation system includes an aggregator device that collects usage activity data from multiple customers' premises 140. For example, the customers' premises 140 may belong to a specific geographic region (e.g., zip code, city, state, county, neighborhood, etc.). According to an exemplary embodiment, the aggregator device analyzes the usage activity data to identify the usage patterns across multiple users. According to an exemplary embodiment, the aggregator device identifies the usage pattern based on a pattern recognition metric. By way of example, the aggregator device may identify that all, most, or some threshold value (e.g., percentage) of users have living room lamps on during the hours between 7 p.m. through 9 p.m., Monday through Friday. The aggregator device generates a configuration setting corresponding to a user activity mode based on the usage pattern.

According to an exemplary embodiment, the aggregator device provides configuration settings to the automation systems of the users using a push or a pull method. According to an exemplary embodiment, users may opt in or opt out of the service that provides configuration settings in accordance with the user activity mode. For example, according to an opt out scenario, a user may elect to have no usage activity data sent to the aggregator device, as described herein. Alternatively, according to an opt in scenario, the user may elect to have only particular usage activity data (e.g., in terms of which controllable elements, time of day, day, etc.) sent to the aggregator device. In this way, the user may authorize any release of information and/or use thereof by the service provider.

According to an exemplary embodiment, the aggregator device includes a behavioral analytics engine that operates in a manner similar to that previously described. Additionally, according to an exemplary embodiment, the aggregator device includes a database that stores usage activity data in a manner similar to that previously described. According to an exemplary embodiment, the aggregator device may store user preferences pertaining to the users.

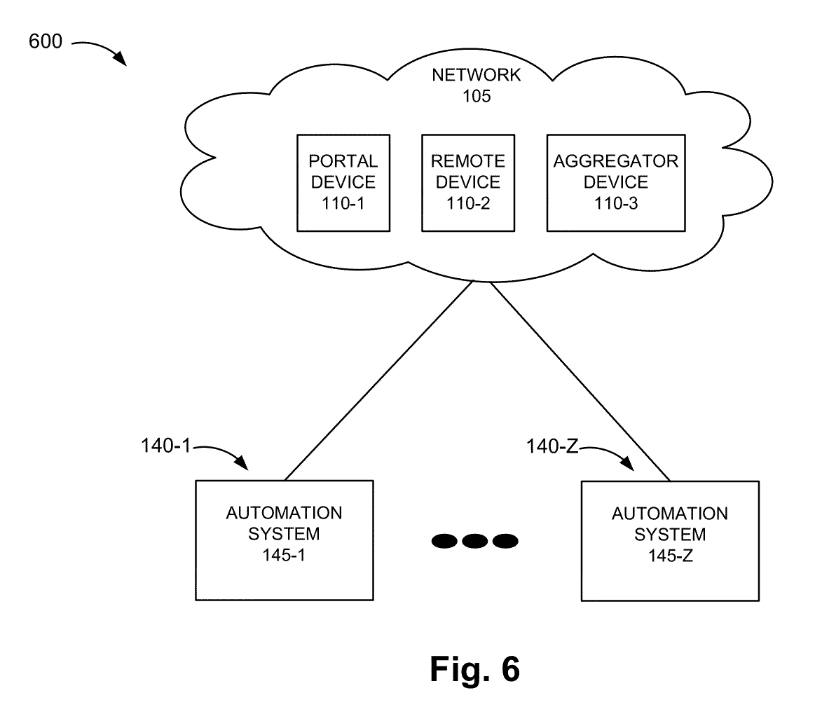

FIG. 6 is a diagram illustrating an exemplary environment in which an exemplary embodiment of an automation system including a user activity mode based on an aggregator device may be implemented. As illustrated, environment 600 includes network 105 and customers' premises 140-1 through 140-Z (also referred to collectively as customers' premises 140). Network 105 includes portal device 110-1, remote device 110-2, and an aggregator device 110-3. Customers' premises 140 include automation systems 145-1 through 145-Z (also referred to collectively as automation systems 145). In contrast to exemplary environment 100 illustrated in FIG. 1A, environment 600 includes aggregator device 110-3. The remaining devices (e.g., portal device 110-1, automation system 145, etc.) may operate as described above. However, according to an exemplary embodiment, control device 153 does not include behavioral analytics engine 210. According to other embodiments, control device 153 includes behavioral analytics engine 210. According to an exemplary embodiment, control device 153 includes a database to store usage activity data.

The number of devices and networks, and the configuration in environment 600 are exemplary. According to other embodiments, environment 600 may include additional devices, fewer devices, different devices, and/or differently arranged devices, than those illustrated in FIG. 6. Additionally, or alternatively, environment 600 may include an additional network and/or a differently arranged network, than those illustrated in FIG. 6.

According to other embodiments, a single device in FIG. 6 may be implemented as multiple devices. Alternatively, for example, multiple devices in FIG. 6 may be implemented as a single device. For example, multiple devices of network devices 110 may be implemented as a single device. A device may be implemented according to one or multiple network architectures (e.g., a client device, a server device, a peer device, a proxy device, or a combination thereof).

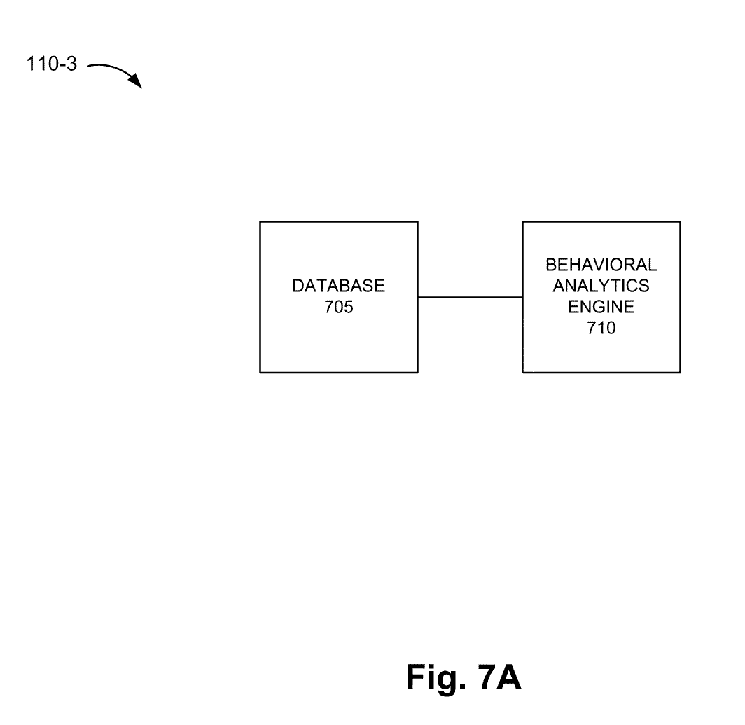

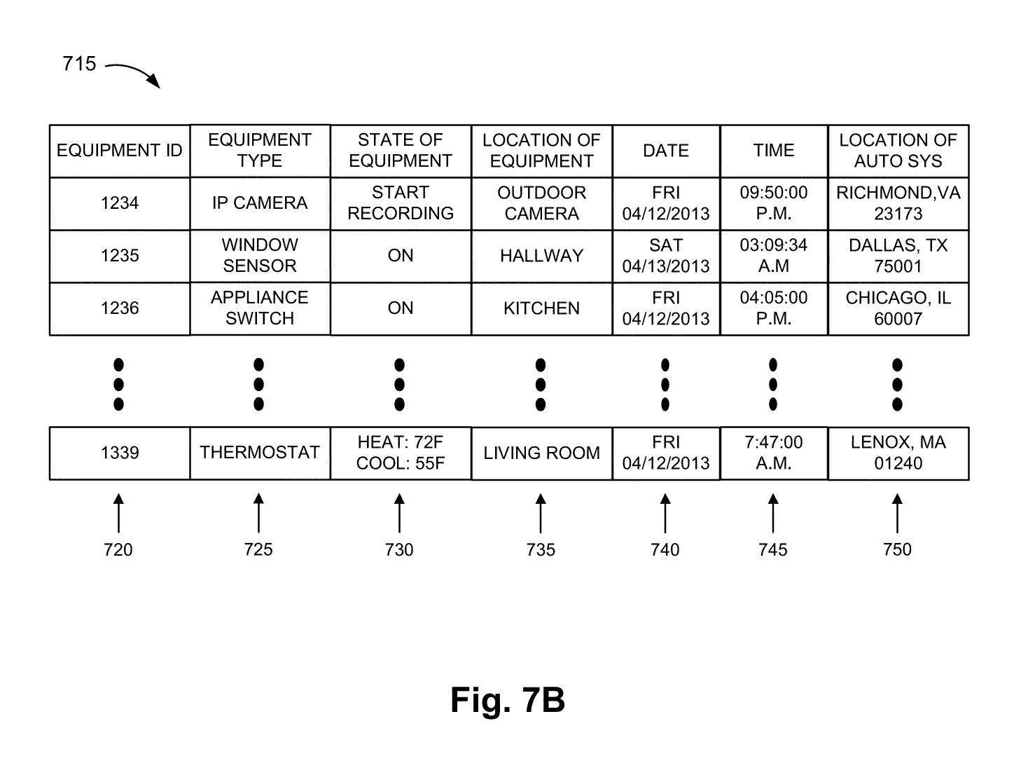

FIG. 7A is a diagram of an exemplary embodiment of aggregator device 110-3. As illustrated, aggregator device 110-3 includes a database 705 and a behavioral analytics engine 710.

Database 705 stores usage activity data. The usage activity data relates to the operation of automation system 145. FIG. 7B is a diagram of exemplary usage activity data. As illustrated, an exemplary table 715 includes an equipment identifier field 720, an equipment type field 725, a state of equipment field 730, a date field 735, a time filed 745, and a location of automation system field 750. According to other implementations, table 715 may include additional fields, fewer fields, and/or different fields than those illustrated and described herein. For example, table 715 may include a user identifier field that identifies the user or automation system 145 (e.g., a unique string) associated with the user. Additionally, or alternatively, table 715 may include a season field that indicates a season of the year (e.g., spring, winter, etc.).

Equipment identifier field 720 stores data that indicates or identifies a controllable element 150 of automation system 145. For example, controllable element data may uniquely identify an appliance switch, a video camera, a door lock, a motion sensor, a door sensor, etc.

Equipment type field 725 stores data that indicates a type of controllable element 150. For example, equipment type data may indicate whether controllable element 150 is a camera, an appliance switch, a thermostat, a sensor, etc.

Equipment state field 730 stores data that indicates a state or an action of controllable element 150. Depending on controllable element 150, state data may be different relative to other controllable elements 150. For example, if controllable element 150 is an appliance switch, state data may indicate an on state or an off state. If controllable element 150 is a video camera, state data may indicate a play state, a record state, etc. Additionally, state data may indicate a position or orientation of a video camera (e.g., X, Y, and Z axes) or other operation (e.g., panning left to right, zooming, etc.) relating to the video camera. Similarly, if controllable element 150 is a door lock element, state data may indicate a locked state, an unlocked state, etc. Other states may be envisioned in correspondence to the type of controllable element 150.

Location of equipment field 735 stores data that indicates a locale of controllable element 150. For example, locale data may be relative to a home or a building. By way of example, the locale data may indicate a room (e.g., kitchen, living room, bedroom, etc.). The locale data may indicate an outside locale in relation to the home or the building (e.g., outside on front porch, backyard, front yard, front oak tree, etc.). The locale data may also indicate a position in a room (e.g., left corner of living room), a position relative to a cardinal direction (e.g., right corner of kitchen—east side of home, etc.), a position relative to other features of the home or building (e.g., light near window, motion detector near front door), or some combination thereof. According to an exemplary embodiment, the locale data may be used to provide seasonal updates to configuration settings, as described below.

Date field 740 stores data that indicates a date. For example, date data may indicate a month, a day, and a year pertaining to the state of controllable element 150. Date data may also indicate a day of the week (e.g., Monday, Sunday, etc.). Time field 240 stores data that indicates a time. For example, time data may indicate an hour, a minute, and a second pertaining to the state of controllable element 150. In some instances, time field 240 may store time data that indicates a period of time (e.g., noon-5:00 p.m., afternoon, morning, evening, etc.). In other instances, time field 240 may store time data that corresponds to a timestamp or an instance in time.

Location of automation system field 750 stores data that indicates a geographic location of automation system 145. For example, location of automation system data indicates a city, a state, a zip code, a county, a country, a region (e.g., east coast), and/or some other geographic label.

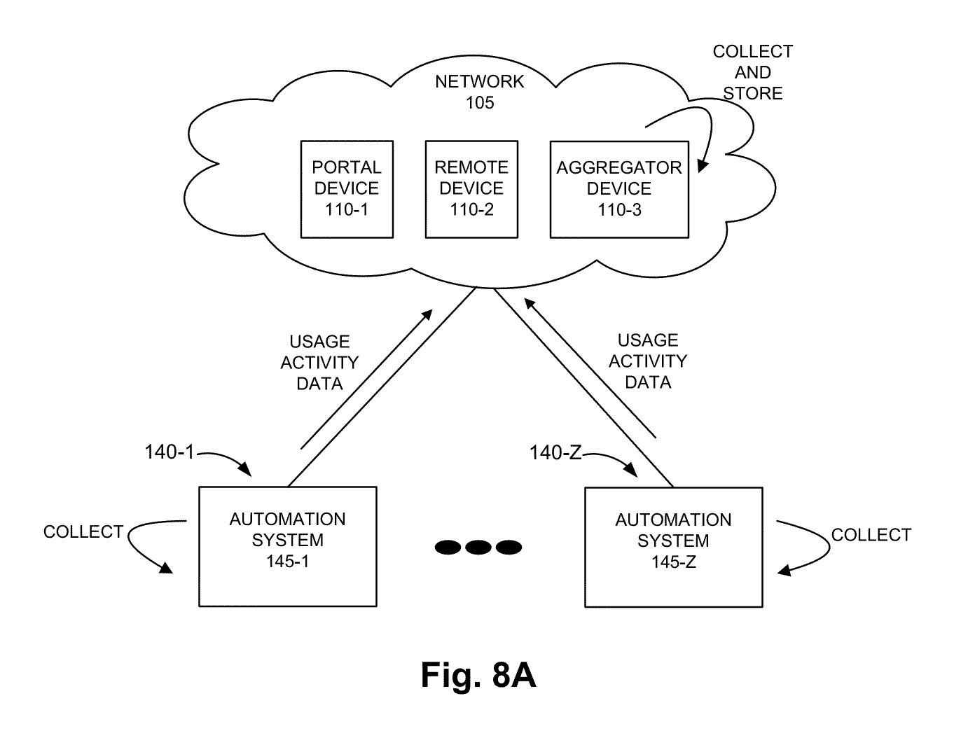

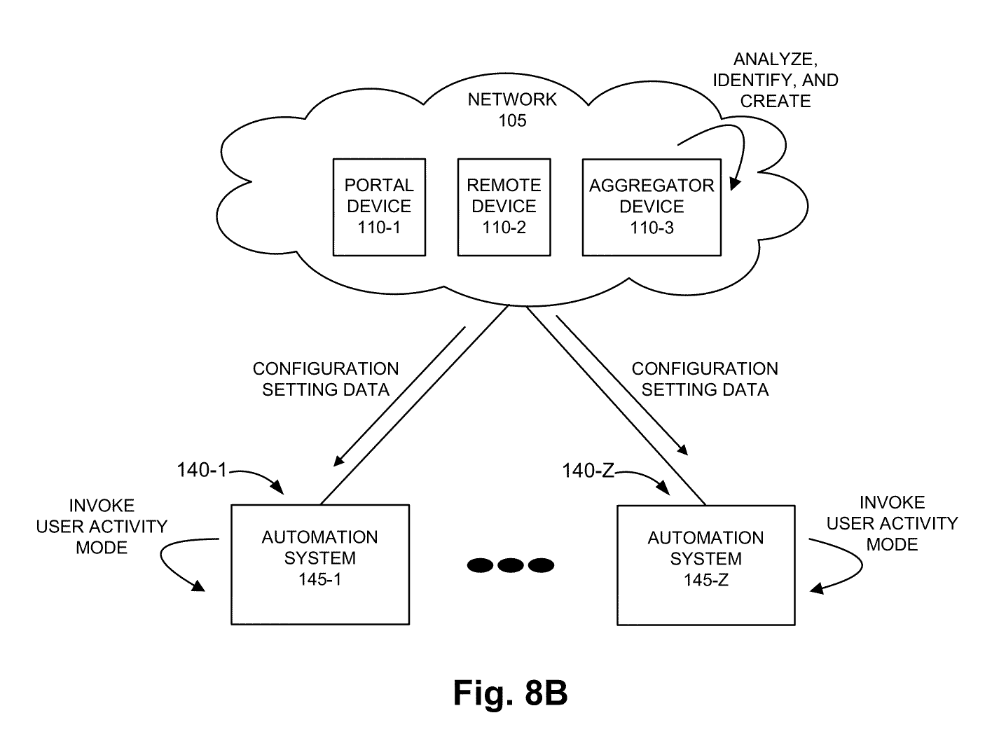

Referring to FIG. 8A, it may be assumed that users of automation systems 145 have opted in to the user activity mode service. According to an exemplary process, automation systems 145 (e.g., control devices 145) collect usage activity data. For example, control devices 145 store the usage activity data in a database. Depending on user preferences, if any, control device 153 may filter the usage activity data. For example, the user may select to opt out particular controllable elements 150, a room, a period of time during the week, etc., from the service. As further illustrated in FIG. 8A, aggregator device 110-3 obtains usage activity data from automation systems 145. This may be accomplished using, for example, a push or a pull communication method, and may be performed periodically, in response to polling, etc. Aggregator device 110-3 collects the usage activity data and stores the usage activity data in database 705 (e.g., table 715).

Behavioral analytics engine 710 identifies a usage pattern based on the usage activity data stored in database 705. According to an exemplary embodiment, behavioral analytics engine 710 identifies a usage pattern based on a pattern recognition metric. For example, behavioral analytics engine 710 analyzes each equipment identifier stored in equipment identifier field 720 and the remaining fields of table 715 to identify a pattern of usage based on the pattern recognition metric. According to an exemplary implementation, behavioral analytics engine 710 applies a quantitative metric as a measurement of a usage pattern. By way of example, a frequency-over-time period metric may be used. According to this embodiment, since behavioral analytics engine 710 collects usage activity data from multiple automation systems 145, behavioral analytics engine 710 may apply other quantitative metrics. For example, the number of automation systems 145 sharing a common usage pattern may be required. Additionally, or alternatively, other metrics pertaining to the fields of table 715 may be applied to identify a usage pattern, such as distance between automation systems 145 (e.g., based on location of automation system data), etc. Behavioral analytics engine 710 creates a user activity mode when a usage pattern is identified. For example, behavioral analytics engine 710 creates configuration setting data that control devices 153 use to control the operation of controllable elements 150. The configuration setting data may include data similar to the usage activity data.

According to an exemplary embodiment, behavioral analytics engine 710 creates configuration setting data according to one or multiple categories. For example, configuration setting data may be directed to a particular season (e.g., winter, month (e.g., June), etc.), weekday versus weekend, location (e.g., Virginia versus Massachusetts), time (e.g., morning, afternoon), geography (e.g., by city, by state, etc.), etc. According to an exemplary embodiment, a user may select, via user preferences provided by a user interface of control device 153 or portal device 110-1, the category of configuration setting data. Aggregator device 110-3 provides the appropriate category of configuration setting data based on the user preference.

Referring to FIG. 8B, as described above, aggregator device 110-2 analyzes the usage activity data, identifies a usage pattern, and creates one or multiple user activity modes. Aggregator device 110-3 provides configuration setting data to automation systems 145 using a push or a pull method. Thereafter, automation systems 145 operate in the user activity mode in accordance with the configuration setting data.

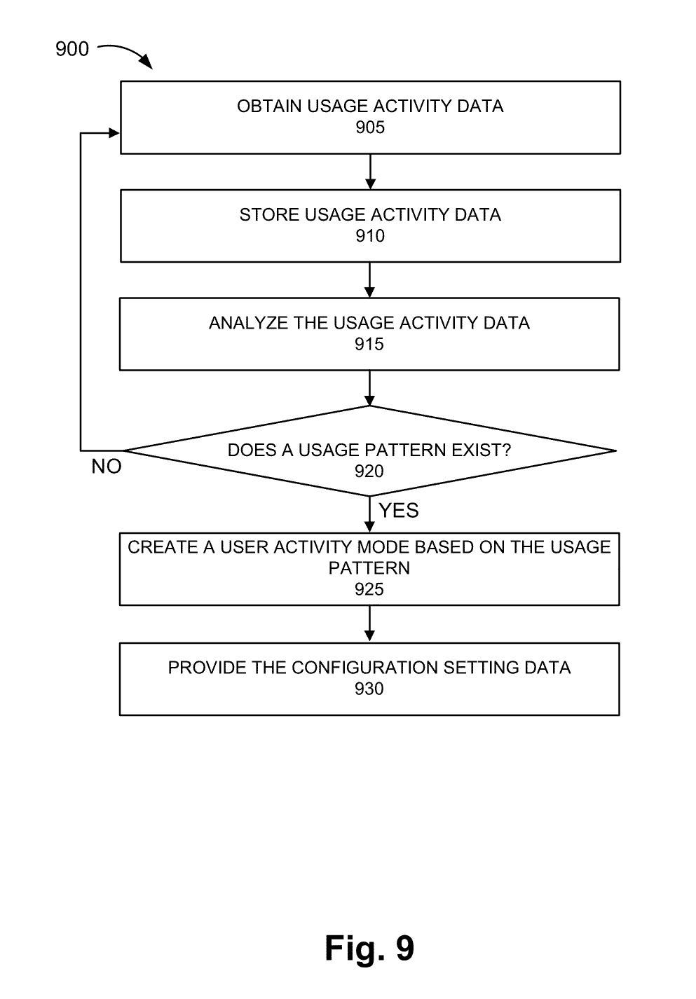

FIG. 9 is a flow diagram illustrating an exemplary process pertaining to an exemplary embodiment of an automation system with an aggregator device. A step described in process 900 is performed by one of the devices illustrated in FIG. 6. For example, processor 405 of aggregator device 110-3 may execute software 415 to perform the step described.

It may be assumed that usage activity data is generated in accordance with the operation of automation systems 145 of customers' premises 140. Process 900 begins with usage activity data being obtained (block 905). For example, via a push or a pull method, aggregator device 110-3 obtains usage activity data from automation systems 145.

In block 910, the usage activity data is stored. For example, aggregator device 110-3 stores the usage activity data of automation systems 145 in database 705.

In block 915, the usage activity data is analyzed. For example, behavioral analytics engine 710 analyzes the usage activity data. For example, as previously described, behavioral analytics engine 710 analyzes the usage activity data based on a pattern recognition metric to determine whether a usage pattern exists. According to an exemplary implementation, the metric includes a frequency-over-time period metric. Behavioral analytics engine 710 may also analyze the usage activity data based on user preferences, as previously described.

In block 920, it is determined whether a usage pattern exists. For example, behavioral analytics engine 710 determines whether a usage pattern exists based on the analysis of the usage activity data. If it is determined that a usage pattern does not exist (block 920—NO), then process 900 continues to block 905. For example, behavioral analytics engine 710 determines that a usage pattern does not exist based on the pattern recognition metric, the user preferences, or a combination of both.

If it is determined that a usage pattern does exist (block 920—YES), then a user activity mode is created based on the usage pattern (block 925). For example, behavioral analytics engine 710 creates a user activity mode based on the recognized usage pattern. As previously described, the behavioral analytics engine 710 creates a configuration setting that includes data corresponding to the usage pattern. For example, configuration setting data may include usage activity data (e.g., an equipment identifier that identifies controllable element 150, state data, date data, time data, etc).

In block 930, the configuration setting data is provided. For example, via a push or a pull method, automation systems 145 obtain configuration setting data from aggregator device 110-3. Thereafter, automation systems 145 operate in a user activity mode in accordance with the configuration setting data.

Although FIG. 9 illustrates an exemplary process 900 to automatically create a user activity mode of operation of an automated system, according to other implementations, process 900 may include additional operations, fewer operations, and/or different operations than those illustrated in FIG. 9 and described herein. For example, automation system 145 or aggregator device 110-3 may provide updates (e.g., based on incremental changes for season, user behavior, etc.) to the configuration setting data in a manner similar to that previously described.

The foregoing description of embodiments provides illustration, but is not intended to be exhaustive or to limit the embodiments to the precise form disclosed. For example, in the preceding specification, various embodiments have been described with reference to the accompanying drawings. However, various modifications and changes may be made thereto, and additional embodiments may be implemented, without departing from the broader scope of the invention as set forth in the claims that follow. The specification and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items.

In addition, while series of blocks have been described with regard to the processes illustrated in FIGS. 5 and 9, the order of the blocks may be modified according to other embodiments. Further, non-dependent blocks may be performed in parallel. Additionally, other processes described in this description may be modified and/or non-dependent operations may be performed in parallel.

The embodiments described herein may be implemented in many different forms of software executed by hardware or hardware. For example, a process or a function may be implemented as “logic” or as a “component.” This logic or this component may include hardware (e.g., processor 405, etc.) or a combination of hardware and software (e.g., software 415). The embodiments have been described without reference to the specific software code since software can be designed to implement the embodiments based on the description herein.

Additionally, embodiments described herein may be implemented as a non-transitory storage medium that stores data and/or information, such as instructions, program code, data structures, program modules, an application, etc. For example, a non-transitory storage medium includes one or more of the storage mediums described in relation to memory/storage 410. The data and/or information may be executed to perform processes or provide functions, as described herein.

In the specification and illustrated by the drawings, reference is made to “an exemplary embodiment,” “an embodiment,” “embodiments,” etc., which may include a particular feature, structure or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

No element, act, or instruction described in the present application should be construed as critical or essential to the embodiments described herein unless explicitly described as such.

What is claimed is:

1. A method comprising:
receiving a request to change a state of one or multiple elements of an automation system;
changing the state of the one or multiple elements based on the request;
storing usage activity data of the one or multiple elements;
analyzing the usage activity data using a pattern recognition metric;
determining whether a usage pattern exits based on the pattern recognition metric;
creating a user activity mode in response to determining that the usage pattern exists; and
operating the automation system in accordance with the user activity mode.

2. The method of claim 1, wherein the automation system includes a home automation system, and wherein the usage activity data includes state data indicating one or more states over time of the one or multiple elements, and wherein the analyzing comprises:
analyzing the state data using the pattern recognition metric.

3. The method of claim 1, wherein the automation system includes an on-demand mode, a scheduled mode, and a triggering mode.

4. The method of claim 1, wherein the pattern recognition metric includes at least one of frequency-over-time period value or a duration of a state over a time period value, and the method further comprising:
alerting a user of the automation system that the usage pattern exists.

5. The method of claim 1, wherein the one or multiple elements include one or more of a video camera, an appliance switch, a door lock, a motion detector, a sensor, or a thermostat, and the method further comprises:
omitting to create the user activity mode in response to determining that the usage pattern does not exist.

6. The method of claim 1, further comprising:
receiving a user request to modify the user activity mode; and
modifying the user activity mode based on the user request.

7. The method of claim 1, further comprising:
automatically updating the user activity mode and an operation of at least one of the one or multiple elements based on a parameter that accounts for a daily change in relation to a season.

8. A system comprising:
a transceiver;
a memory, wherein the memory stores instructions;
a processor, wherein the processor executes the instructions to:
receive a request to change a state of one or multiple elements of an automation system;
change the state of the one or multiple elements based on the request;
store usage activity data pertaining to an operation of the one or multiple elements;
analyze the usage activity data using a pattern recognition metric;
determine whether a usage pattern exits based on the pattern recognition metric;
create a user activity mode in response to a determination that the usage pattern exists; and
control the operation of the one or multiple elements in accordance with the user activity mode.

9. The system of claim 8, wherein the system comprises a control device of a home automation system, and wherein the usage activity data includes state data indicating one or more states over time of the one or multiple elements, and wherein when analyzing, the processor executes the instructions to:
analyze the state data using the pattern recognition metric.

10. The system of claim 8, wherein the system operates according to an on-demand mode, a scheduled mode, and a triggering mode.

11. The system of claim 8, wherein the one or multiple elements include one or more of a video camera, an appliance switch, a door lock, a motion detector, a sensor, or a thermostat, and the processor executes the instructions to:
omit to create the user activity mode in response to determining that the usage pattern does not exist.

12. The system of claim 9, wherein the processor executes the instructions to:
receive a user request to modify the user activity mode; and
modify the user activity mode based on the user request.

13. The system of claim 9, wherein the processor executes the instructions to:
automatically update the user activity mode based on a parameter that accounts for a daily change in relation to a season; and
automatically update the user activity mode based on user behavior when the system operates in the user activity mode, wherein the user behavior indicates negative reinforcement of a configuration directed towards at least one of the one or multiple controllable elements.

14. A method comprising:
obtaining usage activity data pertaining to an operation of multiple automation systems, wherein each automation system includes one or multiple controllable elements;
storing the usage activity data;
analyzing the usage activity data using a pattern recognition metric;
determining whether a usage pattern exits based on the pattern recognition metric;
creating a user activity mode in response to determining that the usage pattern exists, wherein the creating includes generating configuration setting data; and
providing the automation systems with the configuration setting data.

15. The method of claim 14, wherein the pattern recognition metric includes a frequency-over-time period metric, a number of automation systems metric, and a location of multiple automation systems metric.

16. The method of claim 14, wherein the user activity mode is directed to one or more categories, wherein the one or more categories include one or more of a season category, a weekday category, a weekend category, a location category, or a time category.

17. The method of claim 14, further comprising:
automatically updating the user activity mode and an operation of at least one of the one or multiple elements based on a parameter that accounts for a daily change in relation to a season.

18. The method of claim 14, further comprising:
receiving a user preference that indicates whether to average times, select the earliest time, or select a time closest to a predefined increment, wherein the user preference is used to generate the configuration setting data.

19. A non-transitory storage medium storing instructions executable by a computational device, wherein the instructions comprise instructions to:
receive a request to change a state of one or multiple elements of an automation system;
change the state of the one or multiple elements based on the request;
store usage activity data pertaining to an operation of the one or multiple elements;
analyze the usage activity data using a pattern recognition metric;
determine whether a usage pattern exits based on the pattern recognition metric;
create a user activity mode in response to a determination that the usage pattern exists; and
control the operation of the one or multiple elements in accordance with the user activity mode.

20. The non-transitory storage medium of claim 19, wherein the instructions comprise further instructions to:
cause the one or multiple elements to operate according to an on-demand mode, a scheduled mode, and a triggering mode.

21. The non-transitory storage medium of claim 19, wherein the instructions comprise further instructions to:
automatically update the user activity mode based on a time parameter that accounts for a daily change in relation to a season; and
automatically update the user activity mode based on user behavior when the system operates in the user activity mode, wherein the user behavior indicates negative reinforcement of a configuration directed towards at least one of the one or multiple controllable elements.

22. The non-transitory storage medium of claim 19, wherein the instructions comprise further instructions to:
receive a user preference that indicates to omit at least one of the multiple elements or a time period of operation of the one or multiple elements when analyzing the usage activity data.
